(19) United States
(12) Patent Application Publication
(10) Pub. No.: US 2006/0260729 A1
(43) Pub. Date: Nov. 23, 2006

(54) Lightweight safety support for tires

(75) Inventors: Michael Cogne, Riom (FR); Pascal Raby, Chamalieres (FR); Lucien Silvain, Clermont-Ferrand (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., GRANGES-PACCOT (CH)

(21) Appl. No.: 11/418,956

(22) Filed: May 5, 2006

Related U.S. Application Data
(63) Continuation of application No. PCT/EP04/12680, filed on Nov. 10, 2004.

(30) Foreign Application Priority Data
Nov. 10, 2003 (FR) 03/13169

(51) Int. Cl. B60C 17/02

(52) U.S. Cl. 152/520; 152/158

(57) ABSTRACT

A safety support adapted to be mounted on a rim within a tire fitted on a vehicle, to support the tread of the tire in the event of a loss of inflation pressure. The safety support includes a substantially cylindrical base adapted to be fitted around the rim; a substantially cylindrical crown adapted to come into contact with the tread in the event of a loss of pressure, and leaving a clearance relative to the tread at rated pressure; an annular body for connecting the base and the crown. The support is produced, at least in part, by axially assembling a number of annular sections, such that each of the annular sections includes, regularly distributed over the circumference, connecting walls of substantially axial orientation extending at least over part of the annular body and adapted to cooperate with the connecting walls of the adjacent annular section(s) in order to axially assemble the annular sections.

### CROSS-REFERENCE TO RELATED APPLICATIONS

This application is a continuation of International Application PCT/EP2004/012680, filed Nov. 10, 2004, which claims priority to French Patent Application 03/13169, filed Nov. 10, 2003, both of which are incorporated herein by reference in their entirety.

### BACKGROUND OF THE INVENTION

1. Field of the Invention

The present invention relates to safety supports for mounting on a rim within a tire fitted on a vehicle, to support the tread of the tire in the event of a loss of inflation pressure.

2. Description of Related Art

Attempts have been made for several decades to produce supports designed so as to permit minimal driving of the vehicle, under certain conditions (in particular low-speed conditions), for a certain distance (generally a very short one), despite a loss of inflation pressure from a tire or “LOP” which may be as much as a total loss of the pressure or “run flat”. Without the presence of such supports, the rim will almost immediately destroy the tire if travel is continued.

Various solutions have been proposed, in particular by U.S. Pat. No. 5,891,279 (counterpart to EP 0 796 747 A1) and U.S. Pat. No. 6,564,842 (counterpart to WO 00/76791), both of which are incorporated herein by reference. These patents disclose supports comprising axial recesses, that is to say recesses oriented in the direction of the axis of rotation of the support, which are intended to reduce the weight of the support. These recesses comprise practically no undercut part in order to permit demoulding of the supports at the end of their injection cycle. This constraint restricts the design possibilities for these supports.

There is, however, a great and recognized need directed at reducing the weight of the support, naturally without adversely affecting the endurance performance of the mounted assembly (tire, wheel and support) and the behavior of the vehicle.

U.S. Pat. No. 5,685,926 describes a non-pneumatic tire comprising a cellular structure with radial cells of varied form. “Radial cells” are understood to be cells having walls which extend in a direction passing substantially through the axis of rotation of the structure and perpendicular thereto. The walls of the cells of this structure are produced by assembling undulating plates of constant thickness (see FIG. 8 of the document). The result is that these walls of the cells have a thickness which is systematically doubled in the gluing zones and constant in the rest of the structure, which limits optimization of this structure.

It is desirable to reduce the weight of the support while retaining or even improving its mechanical properties such as buckling resistance, stiffness and naturally endurance and permissible speeds when traveling on a flat tire.

For automobile manufacturers, such a reduction in weight is a critical parameter which determines the commercial significance of the support. The invention therefore does not relate to a minor problem, but rather to an essential problem which is a mandatory technical requirement.

Improving, or at least not degrading, the buckling resistance (that is to say the resistance to the axial extension of the body or the partitions under a radial load) is also crucial, because the life of the support depends greatly thereon.

### SUMMARY OF THE INVENTION

The subject of the invention is a safety support for mounting on a rim within a tire fitted on a vehicle, to support the tread of the tire in the event of a loss of inflation pressure. The safety support includes a substantially cylindrical base adapted to be fitted around the rim; a substantially cylindrical crown adapted to come into contact with the tread in the event of a loss of pressure, and leaving a clearance relative to the tread at rated pressure; and an annular body for connecting the base and the crown. The support further includes a plurality of annular sections, each comprising, regularly distributed over the circumference thereof, connecting walls of substantially axial orientation, the connecting walls being adapted to cooperate with the connecting walls of the adjacent annular section(s) for axial assembly of the annular sections.

The connecting walls may extend radially at least over part of the annular body. They may also comprise connecting walls extending circumferentially at least over part of the annular body.

The axial assembly of the annular sections makes it possible to obtain, at the level of the annular body of the support, connecting zones between adjacent sections of constant, well-controlled thickness, because assembly takes place by butt-joining the axial ends of the connecting walls.

Preferably, the annular sections comprise partitions arranged at the level of the annular body, extending radially between the base and the crown of the support, and forming a circumferentially continuous supporting element.

Assembly of these annular sections will thus form cells defined by these partitions and the connecting walls, which have a radial orientation, that is to say that they extend substantially from the base of the support to its crown. The thickness of these cells is linked to the thicknesses selected for the partitions and the connecting walls.

These partitions may constitute supporting elements in the form of a dogleg line. In this case, each partition of the dogleg line can be extended substantially axially by a connecting wall to form, after assembly of the annular sections, cells of hexagonal section in the form of a honeycomb. The thicknesses of all the walls can easily be identical or not, depending on the decision of the designer of the support.

When the connecting walls have an axial length substantially equal to half the length of a partition, the hexagonal cells obtained may be regular hexagons. It is this structure which exhibits the best resistance to buckling upon radial loading.

The partitions may also constitute supporting elements in the form of a circumferential web to constitute cells of rectangular section after assembly of the annular sections.

The partitions may also constitute supporting elements in the form of a sinusoidal line.

According to another embodiment of a support according to the invention, the annular sections may comprise partitions forming circumferentially discontinuous supporting elements.

By way of example, such partitions may comprise radial partitions inclined axially to constitute, after assembly supporting elements of the annular body of the support in the form of chevrons. One of the advantages of a geometry of this type is to reduce very significantly the flexural rigidity of the whole of the support compared with a support which comprises circumferentially continuous supporting elements. This facilitates the operations of mounting the supports and, in particular, their introduction into the torus of the tire, which constitutes the first step of these assembly operations.

Each partition of the annular sections may, axially at least on one side, be extended axially by a connecting wall. In another embodiment, each axial end of the partitions may constitute the connecting wall.

The annular sections according to the invention may also comprise a conventional circumferentially continuous crown.

This crown may also be circumferentially discontinuous. As in the case of the supporting elements in the form of chevrons, a discontinuous crown even more substantially reduces the flexural stiffness of the support, which facilitates the mounting and the dismounting of the tire/support/wheel mounted assembly.

The annular sections may comprise connecting walls which comprise radially the crown of the section. This makes it possible to have a support assembled with an axially continuous crown. The connecting walls may also extend radially to the level of the crown.

The crown may also be axially discontinuous. In any case, it is advantageous not to have a circumferentially and axially continuous crown whatever the azimuth in order to limit the flexural stiffness of this crown and also to reduce the weight of the support. Preferably, the discontinuities of the crown are arranged radially outside the walls of the cells of the annular body.

The supports according to the invention may be produced with sections of support comprising a circumferentially continuous base.

Preferably, the base of these supports comprises means for resisting centrifugation forces. And each of the annular sections of a support may comprise part of these means for resisting centrifugation.

The supports according to the invention may comprise annular sections assembled by gluing.

These supports may advantageously comprise annular sections formed of a thermoplastic elastomer and assembled by mirror welding. The assembly can also be effected by ultrasonic welding.

The annular sections may also be assembled by mechanical clipping of the connecting walls.

The annular sections arranged axially to the outside of a support may comprise connecting walls only on one axial side. These sections may also be made from a material of rigidity greater than that of the material constituting the other annular sections.

The supports according to the invention may also comprise annular sections produced by assembling a set of segments of annular sections. The number of these segments may be between 2 and 30. When the number of these segments is high, close to 30, the segments can then be injected motif by motif of the supporting elements or of the crown.

The supports according to the invention may comprise 2 to 14 annular sections. The assembly of two annular sections already provides very significant freedom in designing the support, and when the number is close to 14, each section has an axial width of the order of 10 mm, thus being an object which is very easy to produce by injection.

The subject of the invention is also a safety support for mounting on a rim within a tire fitted on a vehicle, to support the tread of this tire in the event of a loss of inflation pressure. The safety support includes a substantially cylindrical base adapted to be fitted around the rim; a substantially cylindrical crown adapted to come into contact with the tread in the event of a loss of pressure, and leaving a clearance relative to the tread at rated pressure; and an annular body comprising supporting elements of substantially radial orientations connecting the base and the crown. The supporting elements extend substantially axially from one side of the annular body of the support to the other and have at least two inversions of their direction of curvature.

Such supports comprise axial recesses which cannot be produced in a single operation by injection into a mould owing to the existence of zones of the support which are in an undercut arrangement. Such a support may be produced using a technology close to that of the tires themselves, that is by injecting the base and the annular body of the support into a mould comprising radially displaceable molding elements; after molding the annular body and the base of the support, it is advisable to mould a crown over the whole.

Such supports may also be produced by axially assembling annular sections.

Advantageously, the supporting elements are in the form of chevrons, or straight or rounded.

Another subject of the invention is also an annular section suitable for forming a support according to the invention, and also a segment of an annular section suitable for forming an annular section after assembly.

### BRIEF DESCRIPTION OF THE DRAWINGS

A number of embodiments of supports and annular sections according to the invention will now be described by means of the appended drawing, in which:

FIG. 1 is a side view of a safety support;

FIG. 2 is an axial section through the safety support of FIG. 1 mounted on a wheel rim and in a support configuration against a tire;

FIGS. 3a and b show partial perspective views of an annular section of a support according to the invention;

FIG. 4 shows, viewed in a partial perspective view, a safety support according to the invention;

FIG. 5 shows a first example of an annular section having a supporting element in the form of a dogleg line;

FIGS. 6a and b, 7, 8 and 9 show, in section AA, four examples of supports according to the invention obtained by assembly of sections of FIG. 5;

FIGS. 10 and 11 show, in section AA, another two examples of supports according to the invention obtained by assembly of sections with supporting elements in the form of circumferential webs;

FIGS. 12a and b show an annular section having a sinusoidal supporting element and a support resulting from assembling such sections;

FIGS. 13a and b show an annular section with discontinuous supporting elements and a support resulting from assembling such sections;

FIGS. 14a and b show an annular section close to the previous one and a support resulting therefrom;

FIGS. 15a and b show a perspective view of another support with supporting elements in the form of chevrons;

FIGS. 16a and b illustrate a second mode of assembly of the annular sections by embedding;

FIG. 17 shows a support close to that of FIG. 13 with a circumferentially discontinuous crown;

FIG. 18 shows, in a side view, a support similar to that of FIGS. 10 and 11; and

FIG. 19 diagrammatically illustrates an assembly of segments of annular sections to form one annular section.

### DETAILED DESCRIPTION OF THE PREFERRED EMBODIMENT

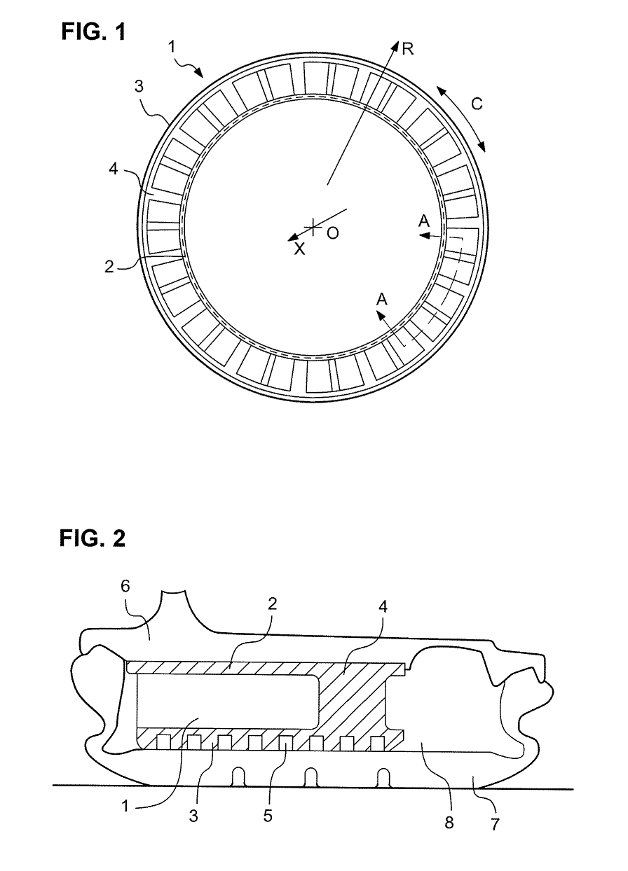

FIG. 1 shows, in a side view, a safety support 1 described in U.S. Pat. No. 6,564,842. This support essentially comprises three parts: a base 2, of generally annular shape; a substantially annular crown 3, intended to support the tread of a tire in the event of loss of pressure therefrom, with longitudinal grooves 5 (optionally) on its radially outer wall; and an annular body 4 for connecting the base and the crown.

FIG. 1 also specifies the geometric conventions used in the present application. The axis X passing through O is the axis of rotation of the support (axis X is perpendicular to the plane of FIG. 1). After the support has been mounted in the cavity of a tire and around a rim, the axis X is also the common axis of rotation of the support, the tire and the rim. The direction R is a radial direction, that is to say, one passing through the axis X and perpendicular thereto. The direction C is a circumferential direction. At any point of the support, the tire or the rim, this circumferential direction is perpendicular to the radial direction passing through this point and to the axis X.

This support 1 is intended to be mounted around a preferred rim 6 such as shown in FIG. 2 and within the cavity 8 of a corresponding tire 7. Such a rim is described, for example, in U.S. Pat. No. 5,891,279 (EP 0 796 747). FIG. 2 illustrates the function of the safety support 1, which is to support the tread of the tire in the event of a major loss of inflation pressure in the cavity 8.

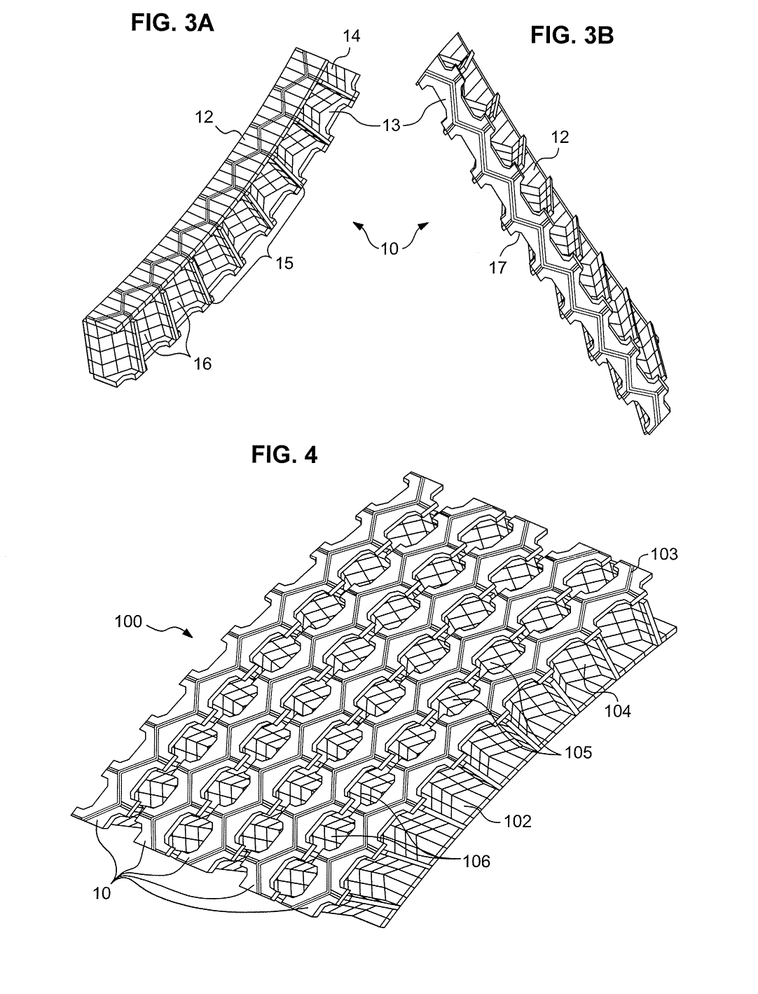

FIGS. 3a and b show partial perspective views of an annular section 10 of a support according to the invention. FIG. 3a is a view from below and FIG. 3b a view from above. These annular sections 10 comprise a base 12, a crown 13 and an annular body 14. This annular body 14 is formed of partitions 16 extending radially between the base and the crown and forming a supporting element in the form of a circumferentially continuous dogleg line. In the example shown, at each end of a partition 16 there is a connecting wall 15 extending substantially axially towards the outside of the annular section. This connecting wall 15 extends radially over the entire annular body 14. The crown 13 of the section 10 is circumferentially continuous but furthermore comprises cutouts 17 arranged radially outside the zones connecting the crown with the partitions 16 and the connecting walls 15. The base 12 preferably comprises means for resisting centrifugation such as reinforcement cords oriented substantially circumferentially. Such reinforcement cords may be made of polyaramid, glass fiber or metal. These means may also be reinforcing grids such as those described in U.S. Patent Application Publication No. 2003/0168142 (counterpart to WO 02/24476), which is incorporated herein by reference.

FIG. 4 shows, in a partial perspective view, a safety support 100 obtained by axial assembly of five annular sections 10. This support thus comprises a circumferentially continuous base 102, a crown 103 which is also circumferentially continuous and comprise cutouts 105 and an annular body 104 formed of radial cells having hexagonal walls in the form of a honeycomb 106. The connections between the annular sections are formed at the level of the adjacent connecting walls 15. These connections may be obtained by any known process, in particular welding or gluing or clipping. This process varies according to the nature of the material of which the annular sections are formed. The cutouts 105 are obtained by axially assembling two adjacent cutouts 17 of the crown of the annular sections 10. The presence of cutouts in the crown has the advantage of reducing the weight of the support 100 but also of limiting its overall flexural rigidity, which facilitates its introduction into the toric cavity 8 of the tire 7, the first step in the assembly on the rim 6, as indicated in U.S. Pat. No. 5,836,366 (counterpart to FR 2 720 977), which is incorporated herein by reference.

The invention is thus based on the concept of manufacture of “annular sections” of a support, then their assembly side by side, to produce the support 100. The very great advantage of this solution is that it permits injection-molding, then easy demoulding, of these annular sections 10. The sole condition for obtaining ready demoulding of the annular sections is that there is no undercut part of the partitions 16. Consequently, the partitions of the annular body 104 of the support 100 may be of virtually any form with regard to the demoulding constraints, and in any case may be selected from among a very large number of practical forms, infinitely greater than those which could have been selected from the prior art. This solution involving the welding or assembly of annular support sections permits a saving in weight which may be of up to about 30%.

It should be noted that the annular sections 10 may or may not comprise a base 12. When the crown 13 or the annular body 14 are circumferentially continuous, the annular sections can be injection-molded and assembled axially in order to obtain a support portion, then a base including, if necessary, the appropriate reinforcement means for resisting centrifugation during travel can be overmolded. This process also applies in the case of annular sections which do not comprise a crown.

The partitions 16 of the annular body 14 of the annular sections 10 could in particular be planar or adopt any form which permits easy demoulding, with a variable inclination relative to the circumferential median plane P. This virtual absence of demoulding constraints enables the person skilled in the art to design the partitions and also the base and crown with great freedom in the design, which makes it possible to optimize the weight of the final support with respect to the desired properties with very great effectiveness.

In U.S. Pat. No. 6,564,842 (WO 00/76791), the design of the supports had allowed a very significant improvement in terms of weight, but the freedom of design was still limited by the demoulding constraints of the partitions forming the annular body of the support. These constraints are eliminated with the present invention.

Contrary to what might have been feared, the elimination of these constraints does not result in a complicated manufacturing process.

The invention makes it possible to conceive of numerous forms and variants which are possibly cumulative, as the person skilled in the art will easily be able to determine.

It will be noted that the partitions and supporting elements of each annular section may be identical or different: there may be provided different forms, and/or different inclinations of the partitions relative to the circumferential median plane P, and/or different thicknesses of materials either at the level of one and the same partition, or between two partitions of different annular sections.

It might be possible to conceive of different constituent materials between several categories of annular sections, for example thermoplastic elastomers which are more or less stiff according to the position relative to the lateral edges, or even different materials between the crown and the body or the base, and similar combinations, the only condition being of course that all the materials can be assembled by welding, or by other processes such as ultrasound welding, or even by mechanical clipping, without any problem other than that of adaptations.

In particular, as in the aforementioned patent U.S. Pat. No. 6,564,842 (WO 00/76791), provision could be made for the annular sections forming the central part of the support (that is to say the annular sections containing the circumferential median plane P or close to this plane P) to comprise partitions of greater thickness than that of the partitions of the lateral annular sections, that is to say those forming the edges of the support or close to this edge. This is in order to improve the buckling resistance under radial compressive load.

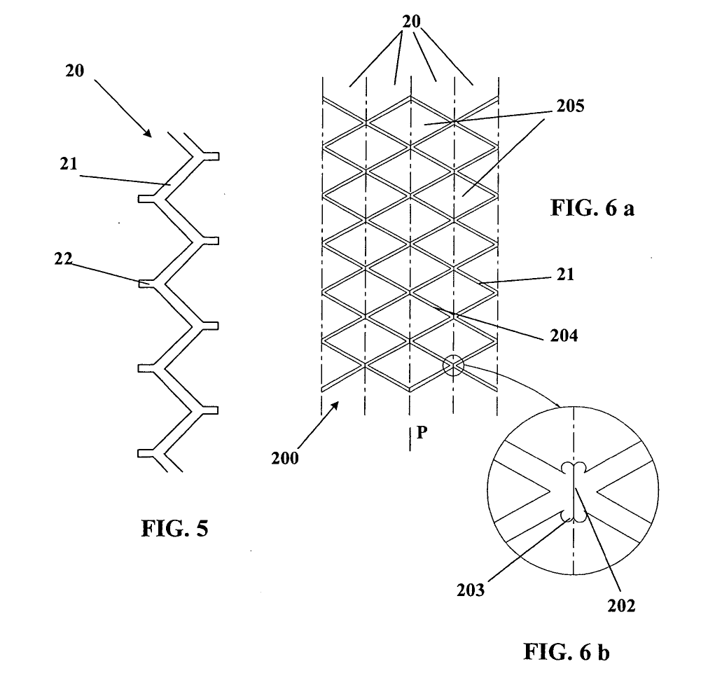

FIG. 5 shows in section AA as indicated in FIG. 1 the partitions 21 of annular sections 20. As in the previous example, these partitions 21 are arranged circumferentially in the form of a continuous dogleg line. At each end of a partition 21 there is an axially oriented connecting wall 22.

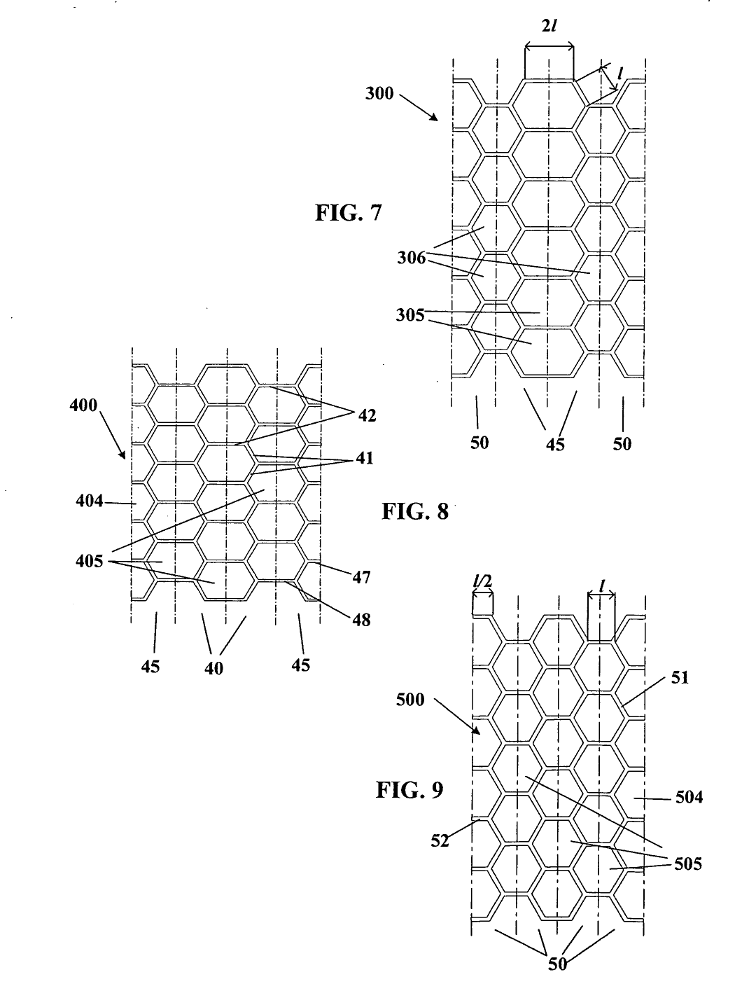

FIG. 6 shows, still in section AA as indicated in FIG. 1, a support 200 obtained by axial assembly of four annular sections 20. This support is formed of a thermoplastic material and assembly is effected by welding the adjacent connecting walls 22. FIG. 6b shows diagrammatically the connection zone between two adjacent walls 22 after gluing. The two walls 22, having been brought to a high temperature, close to their softening point, have been brought into contact until an intimate bond of the macromolecular chains has been achieved. The connecting walls have practically produced solely this connection zone 202 with a bulge 203 on either side of the connection zone 202. The two annular sections 20 arranged on the edge of the support did not comprise connecting walls towards the outside.

The annular body 204 of this support 200 is thus formed of radial cells 205 in the general form of parallelograms. In this example is shown the plane P, the circumferential median plane.

FIGS. 7, 8 and 9 show supports obtained by assembly of four annular sections similar to that shown in FIG. 5 but with connecting walls of different axial lengths.

Considering l as the length of a partition 51, FIG. 9 shows a support 500 which is the assembly of four annular sections 50 comprising partitions 51 in the form of a circumferentially continuous dogleg line and connecting walls 52 of length l/2 at each end of the partitions 51. The length l/2 is the useful length, that is to say, the axial length resulting after assembly. The initial length must be greater by a value that varies as a function of the assembly process and the material constituting the annular section. The annular body 504 of the support 500 thus comprises hexagonal radial cells 505 in the form of a regular honeycomb. This support 500 exhibits excellent buckling resistance under radial compressive load in particular in its central part.

The support 400 of FIG. 8 is formed of the assembly of two annular sections 40, the connecting walls 42 of which on either side have a length of 1, identical to the length of the partitions 41, and two annular sections 45 the connecting walls 47, 48, of which on have on one side an axial length of l(48) and on the other of l/2 (47), arranged at the edge of the support. The result is a support 400, the annular body 404 of which comprises hexagonal radial cells 405 which are elongated axially. This has the advantage of rebalancing the buckling resistance by slightly reducing the resistance in the central part of the support compared with the two edges.

The support 300 of FIG. 7 is obtained by assembly at the center of two annular sections 45 of asymmetrical axial lengths of the connecting walls: l on one side and l/2 on the other, and at the edges of two annular sections 50 of symmetrical axial lengths of the connecting walls: l/2. The result is, at the center, a circumferential row of axially elongated hexagonal cells 305, and adjacent on either side are two rows of regular hexagonal cells 306. This support 300 has a buckling resistance which is reinforced on the edges compared with the central part.

Of course, it is possible to modify the number of annular sections, their forms, their properties, etc., without departing from the scope of this invention.

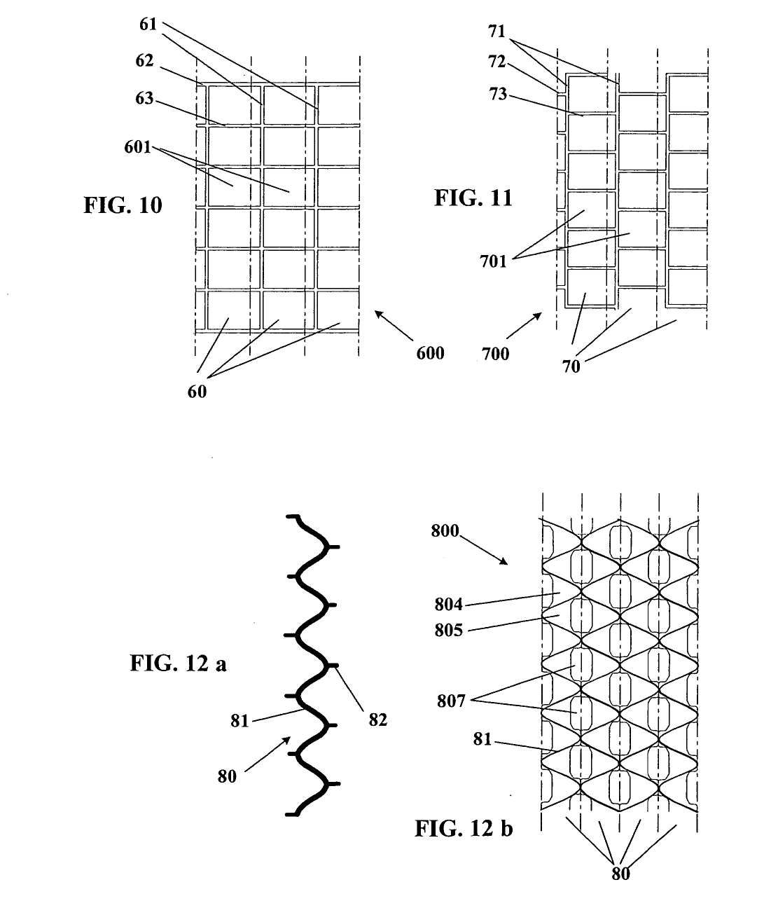

FIGS. 10 and 11 show another two examples of supports 600 and 700 obtained by assembly of annular sections 60, 70 comprising partitions 61, 71 in the form of a circumferential web with connecting walls of asymmetrical axial lengths (62, 63, 72, 73). The annular section 60 has axially aligned connecting walls 62 and 63, which gives a support with radial cells 601 of rectangular form which are aligned axially and circumferentially. The annular section 70 has circumferentially offset connecting walls 72 and 73. Consequently, the support 700 has radial cells 701 of rectangular form which are aligned circumferentially but offset axially. This permits better homogeneity of distribution of the forces.

FIGS. 12a and b, which are similar to the previous figures, show an annular section 80 with sinusoidal partitions 81. The connecting walls 82 are axially limited to the amplitude necessary in order to obtain a good connection. The result for the support 800 is an annular body 804 with radial cells 805 in the form of parallelograms, the sides of which are of sinusoidal form. This figure also diagrammatically indicates how the crown of the annular sections and the support are cut out. This crown comprises cutouts 807 intended as previously to limit the weight and to reduce the stiffness of the support.

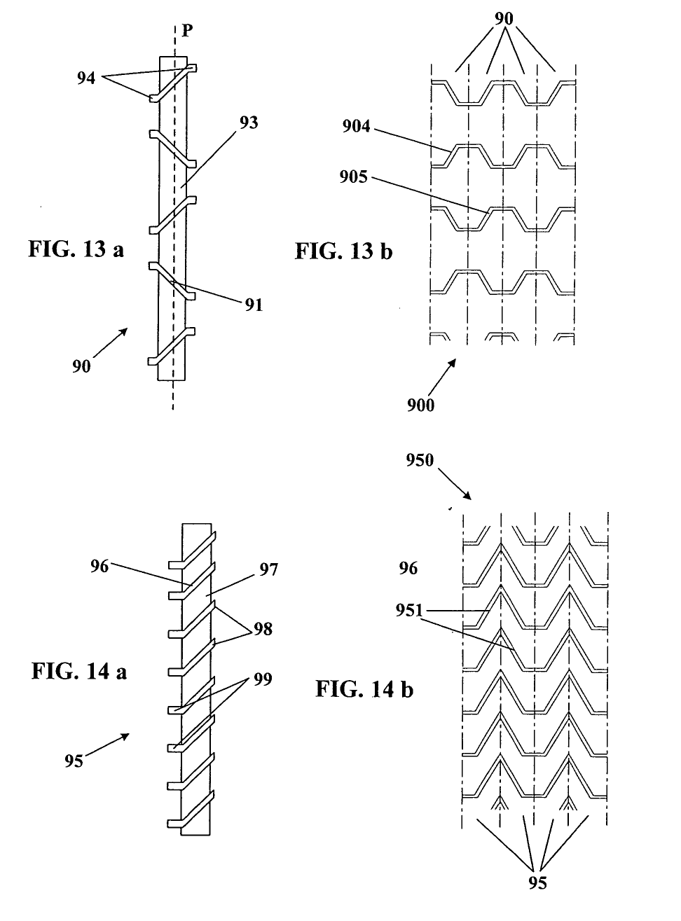

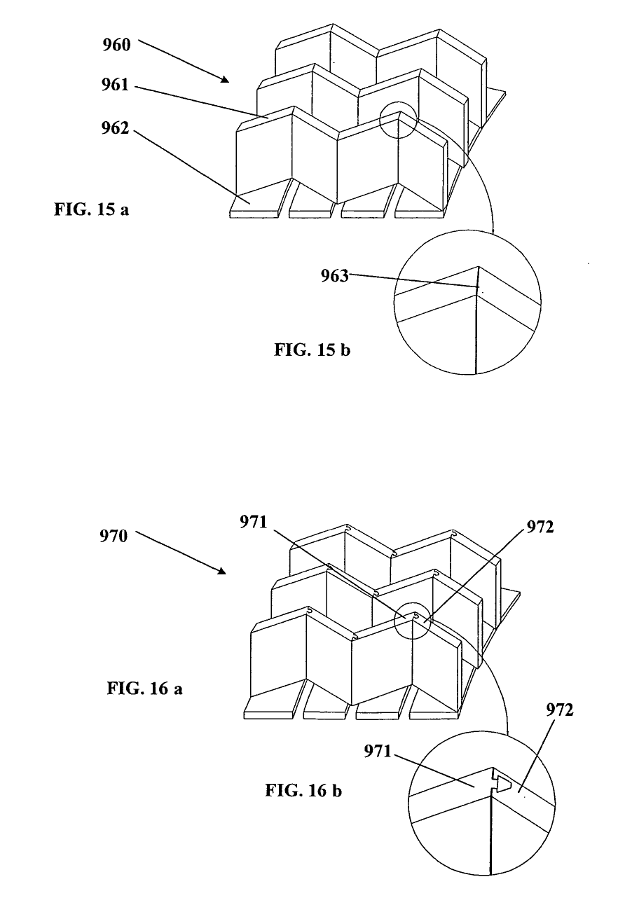

FIGS. 13 and 14 show annular sections 90 and 95, the partitions 91 and 96 of which no longer form a circumferentially continuous supporting element, but one which is discontinuous and of planar form inclined relative to the axial direction. The annular section 90 has partitions 91 of alternating orientations relative to the median plane P, the section 95, partitions 96 of identical orientation over the whole of the circumference. In these figures, the bases 93 and 97 of the annular sections are also shown. These bases are circumferentially continuous and injected at the same time as the partitions and connecting walls.

The result in FIG. 13b is a support 900 obtained by assembling four sections 90, the annular body 904 of which comprises supporting elements 905 extending axially from one edge of the support to the other substantially axially with four changes of curvature. Such a support is impossible to obtain by a single-operation molding technique owing to the impossibility of axially demoulding the object. In this figure, the base of the support is not shown. It should be noted that the bases 93 of the annular sections, after assembly, will not adjoin unless the connecting walls 94 are completely absorbed by the welding process, or unless the walls are assembled by another technique, such as gluing or clipping.

The assembling of four annular sections 95 gives the support of FIG. 14. This support 950 comprises supporting elements 951 in the form of chevrons. As previously, the different axial length of the connecting walls 98 and 99 on either side of the annular sections 95 involves for the widest walls a resulting spacing which is higher after assembly. It should be noted that the connecting walls 98 are not oriented strictly axially but in the extension of the partitions 96. This makes it possible also to produce a good connection and a geometry after assembly of the supporting elements in the form of chevrons.

FIG. 15 shows, in a partial perspective view, a third example of a support 960 with supporting elements 961 in the form of chevrons. The base 962 of this support comprises four adjacent, axially discontinuous, portions corresponding to the bases of the annular sections having served for assembly. This figure shows an example of assembly by gluing the connecting zones 963.

FIG. 16, which is similar to the above FIG. 15, illustrates one possibility of assembling the annular sections by mechanical embedding for the support 970. The two parts 971 and 972 of the connecting walls end in the form of a dovetail and are made to cooperate with each other. In this example, the two outer annular sections are not mechanically anchored.

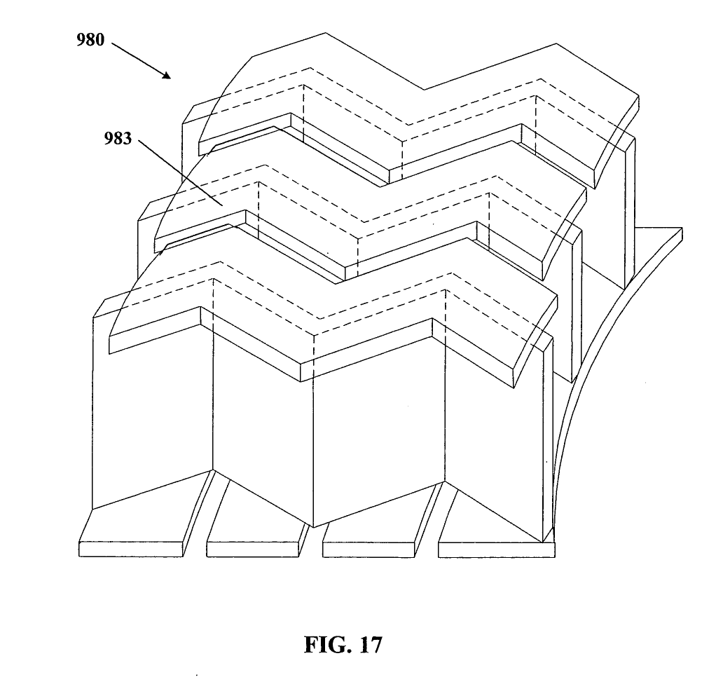

FIG. 17 illustrates a similar figure of the support 980, in a partial perspective view, in which the crown 983 has been shown. This crown 983 is not continuous circumferentially but is axially. Such a discontinuous crown, which must however retain a short distance between two successive motifs, has the advantage of greatly reducing the flexural rigidity of the support. Its operation when traveling on a flat tire may however be satisfactory if the different motifs of the crown can bear on one another upon passing into the contact area. For this, it is useful for the walls adjacent circumferentially to the crown to be separated by a distance of less than a few millimeters, two for example.

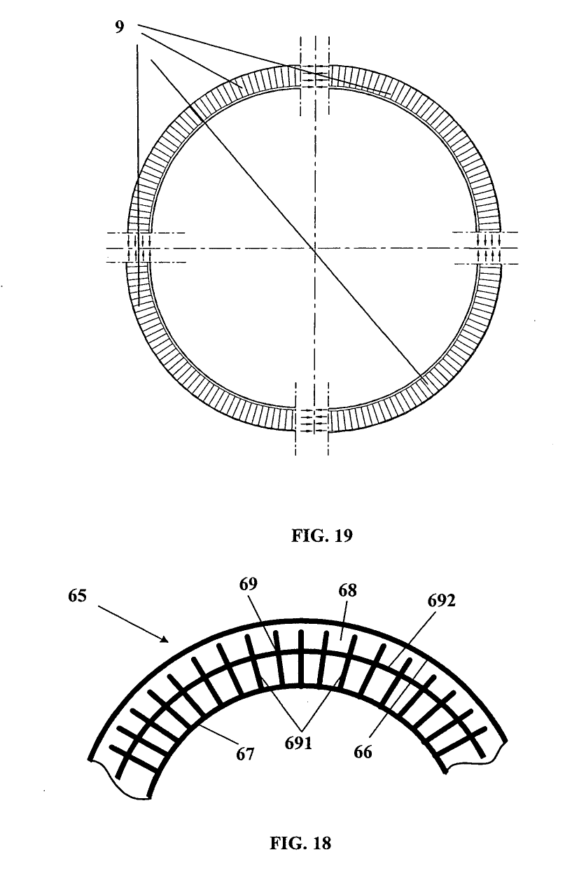

FIG. 18 shows, in a partial side view, an annular section 65 comprising a crown 66, a base 67 and, as the annular sections 60 and 70 of FIGS. 10 and 11, partitions 68 constituting supporting elements in the form of a circumferential web. The connecting walls 69 of this annular section have a dual orientation. The connecting walls 691 extend radially between the base 67 and the crown 66 and the connecting walls 692 extend circumferentially. Preferably, the walls 691 do not reach the crown in order to avoid creating singularities which might damage the inner wall of the tire when traveling on a flat tire. The presence of the walls 692 substantially increases the strength of the connections between the annular sections.

It should also be noted that, as illustrated by FIG. 19, the annular sections may not be molded in a single operation but by assembly of segments 9, of which there are four in the example shown. This assembly may be effected by any known means, in particular gluing, welding or mechanical clipping. Preferably in this case, these segments 9 will comprise a crown and an annular body. It is then possible, after assembling the annular sections and assembling the annular sections together to provide a support part, to overmold a circumferential base on this support portion to give the final support comprising its means for resisting centrifugation.

One other possibility is to inject segments or annular sections with a base which does not comprise means for resisting centrifugation and to add them later for example by winding or gluing.

The assembly of the circumferential sections may be brought about in various known ways on a material of thermoplastic elastomer type which will be the one that will be preferred.

According to one particular embodiment, the assembly will be effected by what is called a “mirror welding” process in which two faces to be assembled are heated, substantially to the softening point, by a heating plate arranged between the two faces, after which the plate is removed and the two faces are pressed against each other. Such a process permits welding by surfaces, or small surfaces, or precise welding points. It is also possible to conceive of more localized welding by ultrasound or infrared and other known methods. In the case of circumferentially extending connecting walls, the temperature of the softening point of the material may be obtained by friction by rotating the annular sections against each other.

The invention also relates to the supports manufactured by the process according to the invention. As these supports are of a geometry unknown from the prior art, the invention also covers these supports as novel industrial products.

What is claimed is:

1. A safety support for mounting on a rim within a tire fitted on a vehicle, to support the tread of the tire in the event of a loss of inflation pressure, comprising:
a substantially cylindrical base adapted to be fitted around the rim;
a substantially cylindrical crown adapted to come into contact with the tread in the event of a loss of pressure, and leaving a clearance relative to said tread at rated pressure;
an annular body for connecting said base and said crown; and
a plurality of annular sections, each comprising, regularly distributed over a circumference thereof, connecting walls of substantially axial orientation, the connecting walls being adapted to cooperate with connecting walls of an adjacent annular section for axial assembly of said annular sections.

2. A support according to claim 1, in which said connecting walls extend radially at least over part of the annular body.

3. A support according to claim 1, in which said connecting walls extend circumferentially at least over part of the annular body.

4. A support according to claim 1, in which at least one of said annular sections comprises partitions arranged at a level of the annular body of said support, the partitions extending radially between the base and the crown of said support, and forming a circumferentially continuous supporting element.

5. A support according to claim 4, in which said partitions of said at least one annular section comprise a supporting element in the form of a dogleg line.

6. A support according to claim 5, in which each partition of said dogleg line of at least two of said annular sections is extended substantially axially by a connecting wall to constitute, after assembly of said annular sections, cells in the form of a honeycomb.

7. A support according to claim 6, in which a length of at least part of said connecting walls is substantially equal to half of a length l of a partition of said dogleg line for at least one of said annular sections.

8. A support according to claim 4, in which said partitions of at least two of said annular sections form supporting elements in the form of a circumferential web to constitute cells of rectangular form after assembly of said annular sections.

9. A support according to claim 8, in which said partitions of at least one of said annular sections comprise connecting walls arranged in an alternating manner on either side of said circumferential web.

10. A support according to claim 4, in which said partitions of at least one of said annular sections form a supporting element in the form of a sinusoidal line.

11. A support according to claim 1, in which at least one of said annular sections comprises partitions arranged radially at the level of the annular body of said support and forming circumferentially discontinuous supporting elements.

12. A support according to claim 11, in which at least two of said annular sections comprise radial partitions inclined axially to constitute, after assembly, an annular body comprising supporting elements in the form of chevrons.

13. A support according to claim 12, in which, axially at least on one side, each partition of at least one of said annular sections is extended axially by a connecting wall.

14. A support according to claim 12, in which, axially at least on one side, each axial end of the partitions of at least one of said annular sections comprises said connecting wall.

15. A support according to claim 1, in which at least one of said annular sections comprises a circumferentially continuous crown.

16. A support according to claim 1, in which at least one of said annular sections comprises a circumferentially discontinuous crown.

17. A support according to one of claims 15 and 16, in which the connecting walls of said annular sections extend radially to a level of the crown of said annular sections.

18. A support according to one of claims 15 and 16, in which said crown comprises cutouts offset axially and circumferentially relative to the partitions of said annular sections of said support.

19. A support according to claim 1, in which at least one of said annular sections comprises a circumferentially continuous base.

20. A support according to claim 19, in which said base of said support comprises means for resisting centrifugation forces.

21. A support according to claim 20, in which each of said annular sections comprises part of said means for resisting centrifugation forces.

22. A support according to claim 1, in which said annular sections are assembled by gluing.

23. A support according to claim 1, in which said annular sections are formed of a thermoplastic elastomer and assembled by mirror welding.

24. A support according to claim 1, in which said annular sections are formed of a thermoplastic elastomer and assembled by ultrasound welding.

25. A support according to claim 1, in which said annular sections are assembled by mechanical clipping of said connecting walls.

26. A support according to claim 1, in which said annular sections arranged axially to the outside of said support, after assembly, comprise connecting walls only on a single axial side.

27. A support according to claim 1, in which said annular sections arranged axially to the outside of said support are made from a material of rigidity greater than that of the material constituting other of said annular sections.

28. A support according to claim 1, in which at least one of said annular sections is produced by assembly of a set of segments of said annular sections.

29. A support according to claim 28, in which the number of segments of each of said annular sections is between 2 and 30.

30. A support according to one of claims 1 and 29, in which the number of said annular sections is between 2 and 14.

31. A safety support for mounting on a rim within a tire fitted on a vehicle, to support the tread of the tire in the event of a loss of inflation pressure, comprising:
a substantially cylindrical base adapted to be fitted around the rim;
a substantially cylindrical crown adapted to come into contact with the tread in the event of a loss of pressure, and leaving a clearance relative to said tread at rated pressure; and
an annular body comprising supporting elements of substantially radial orientations connecting said base and said crown,
wherein said supporting elements extend substantially axially from one side of said annular body of said support to the other, and said supporting elements have at least two inversions of a direction of curvature.

32. A safety support according to claim 31, in which said supporting elements are in the form of a chevron.

33. A support according to claim 31, in which said supporting elements are of a rounded form.

34. An annular section of a safety support for mounting on a rim within a tire fitted on a vehicle, to support the tread of the tire in the event of a loss of inflation pressure, the annular section comprising:
a substantially cylindrical base adapted to be fitted around the rim;
a substantially cylindrical crown adapted to come into contact with the tread in the event of a loss of pressure, and leaving a clearance relative to said tread at rated pressure;
an annular body for connecting said base and said crown; and
connecting walls of substantially axial orientation regularly distributed over a circumference of the annular body, the connecting walls being adapted to cooperate with connecting walls of an adjacent annular section for axial assembly with said annular section.

35. A segment of an annular section adapted to comprise, after assembly, an annular section according to claim 34.
